(19) United States
(12) Patent Application Publication
(10) Pub. No.: US 2017/0245624 A1
(43) Pub. Date: Aug. 31, 2017

(54) MULTIPURPOSE BOTTLE SYSTEM

(71) Applicant: Health Emporium USA LLC, Orlando, FL (US)

(72) Inventor: Cezar Neves, Orlando, FL (US)

(73) Assignee: Health Emporium USA LLC, Orlando, FL (US)

(21) Appl. No.: 15/519,553

(22) PCT Filed: Nov. 16, 2015
(86) PCT No.: PCT/US2015/060951

§ 371 Date: Apr. 17, 2017

Related U.S. Application Data
(60) Provisional application No. 62/080,781, filed on Nov. 17, 2014.

(51) Int. Cl. A45F 3/18; A45C 11/18; A45C 11/32; A47G 19/22; B65D 23/00; B65D 53/02; B65D 43/16; B65D 43/22; B65D 25/20; A45C 11/00; B65D 41/04

(52) U.S. Cl. CPC A45F 3/18; A45C 11/00; A45C 11/182; A45C 11/321; A47G 19/2227; B65D 41/04; B65D 53/02; B65D 43/16; B65D 43/22; B65D 25/205; B65D 23/003; A45C 2011/002; A47G 2019/2244; H02J 7/0042

(57) ABSTRACT

The present invention is a multipurpose bottle that comes with multiple features and functions, such as: insulation to keep the water cool for a longer period of time, a smartphone holder, a smart phone charger, a Bluetooth speaker, an optional fragrance tab and storage space for personal items such as keys, credit cards, money, etc. The present invention provides advantages to people traveling to or from the gym or work, as this multipurpose bottle can keep water cooled, charge the smartphone and hold it, play music through the Bluetooth speaker, and provide aroma therapy while drinking and still store various important personal belongings.

### CROSS-REFERENCE TO RELATED APPLICATIONS

This application is a national phase application of PCT/US2015/060951 and claims priority to a U.S. Provisional Patent Application No. 62/080,781, filed on Nov. 17, 2014, the contents of which are incorporated herein in their entirety by reference.

### BACKGROUND OF THE INVENTION

The present invention relates to a bottle system that is useful in the course of daily household work and activities. More specifically, the present invention is a multipurpose bottle system that has multiple functions and uses. The multipurpose bottle system invention will be very useful for working people, people who travel often, and for people who go to the gym.

At present, there is not a multipurpose bottle system of this type available that has multiple useful features, such as: insulation to keep the water cool for a longer period of time, a smartphone holder, a smart phone charger, a Bluetooth speaker, an optional fragrance tab and storage space for personal items such as keys, credit cards, money, etc. Currently, if people want to carry all these items then they have to use a bag of dimensions of approximately 6×8×10 inches but nevertheless will still be unable to charge smart phones or work as a Bluetooth speaker. While there may be many multipurpose bottles available, none of them have all of the above-mentioned features.

For example, Chinese Patent Number CN203127268 was granted for a multipurpose bottle, but the patent did not cover any of the features as mentioned in the present invention. The inventor of the present multipurpose bottle system is not aware of another multipurpose bottle system that has all the features of the invention disclosed herein which provides advantages for people who need it most, such as those who travel, work, or go to the gym.

In today's technologically-based world, there is a need for a multipurpose bottle system that can provide features such as a smartphone charger, smartphone holder, a Bluetooth speaker, and a storage space to keep important personal items so that they are not misplaced in transit. The present invention provides all such features in a single bottle system.

To the best of the knowledge of the inventor, no other pre-existing invention discloses or has disclosed, prescribes or has prescribed or provides or has provided any such system or method that has features like those in the present invention. No other invention has provided a multipurpose solution for people on the move, and by providing all these utilities in a single multifunctional bottle system, so that its users do not have to carry multiple bags for all of their items. The use of a single container also increases the safety of the user's belongings.

### BRIEF SUMMARY OF THE INVENTION

The present invention has features such as: a water bottle with insulation to keep the water in the bottle cool for a longer period of time, a smartphone holder/charger, a Bluetooth speaker, an optional fragrance tab and storage space for personal items such as keys, credit cards, money etc.

In one aspect, the water bottle system may comprise the insulated water bottle, the smartphone holder/charger, the Bluetooth speaker, the optional fragrance tab and the storage space for personal items such as keys, credit cards, money, etc.

In another aspect, the water bottle system may consist essentially of the insulated water bottle, the smartphone holder/charger, the Bluetooth speaker, and the storage space for personal items such as keys, credit cards, money, etc.

In yet another aspect, the water bottle system may consist of the insulated water bottle, the smartphone holder/charger, the Bluetooth speaker, and the storage space for personal items such as keys, credit cards, money, etc.

The multipurpose bottle system may have single or dual layers for insulation: The first layer contains air to insulate the contents of the bottle (e.g., water) from outside temperatures, and the optional second layer is coated with a gel to keep the water freezing cold.

The multipurpose bottle system may also have a battery integrated with a USB outlet so that people can charge their phone anytime and anywhere. Of course, the battery may be an optional feature and therefore present in some implementations and not present in other implementations. The smartphone holder may have magnets affixed inside, adjacent to or in contact with the bottle to hold the phone straight and firmly attached to the holder. The multipurpose bottle system also may have a Bluetooth speaker installed can be used to play music as well when the phone is in contact with or in proximity of multipurpose bottle system. The bottle system also may have a storage compartment in the base, or elsewhere, to keep personal belongings safe, such as credit cards, ID cards, keys, money, etc.

These, and other features and advantages of the present invention, will be clearly visible and apparent to persons reading the entirety of this disclosure, which includes accompanying drawings and claims.

### BRIEF DESCRIPTION OF EACH VIEW OF THE DRAWING

FIG. 1 shows the front view of the multipurpose bottle system.

FIG. 2 shows the back and bottom view of the multipurpose bottle system.

FIG. 3 shows the functionality of the components of the multipurpose bottle system.

FIG. 4 shows the descriptive view of the components of the multipurpose bottle system.

FIG. 5 shows the configuration of the wall of the bottle of the multipurpose bottle system of FIG. 3.

### DETAILED DESCRIPTION OF THE INVENTION

In the present disclosure, numerous specific details are provided such as the modules, components and method, to provide a thorough understanding of the embodiments of the invention. This description is not exhaustive, however, as some of the more well-known details of certain parts are common and not shown here.

In general, the multipurpose bottle system disclosed herein includes the following key components: a water bottle, a blue tooth speaker system, a cell phone mounting apparatus, and a battery system for charging a cell phone.

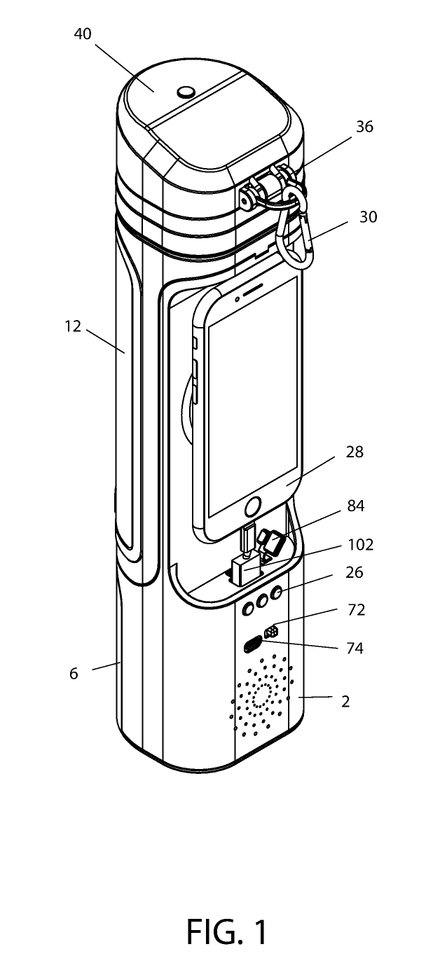

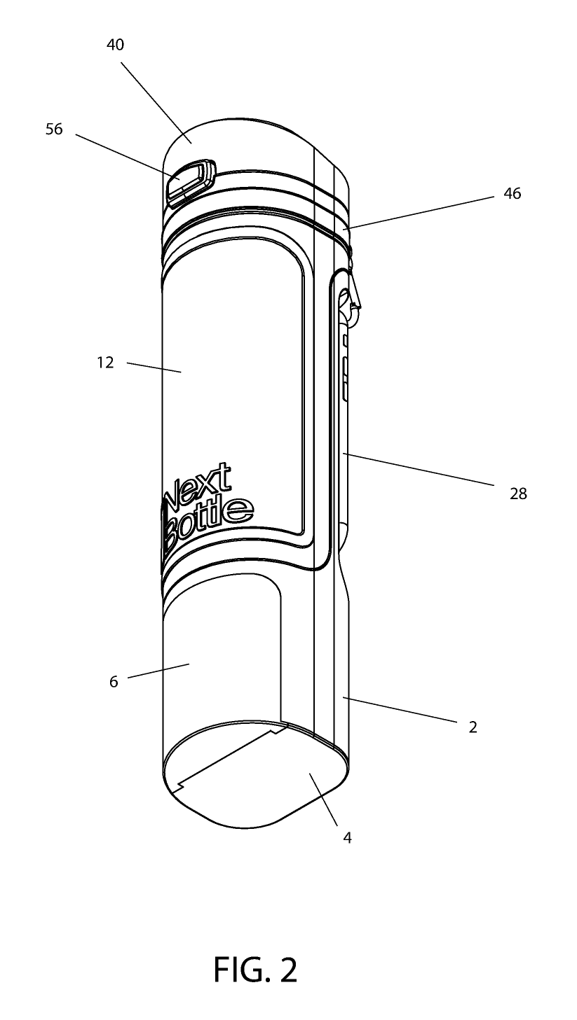

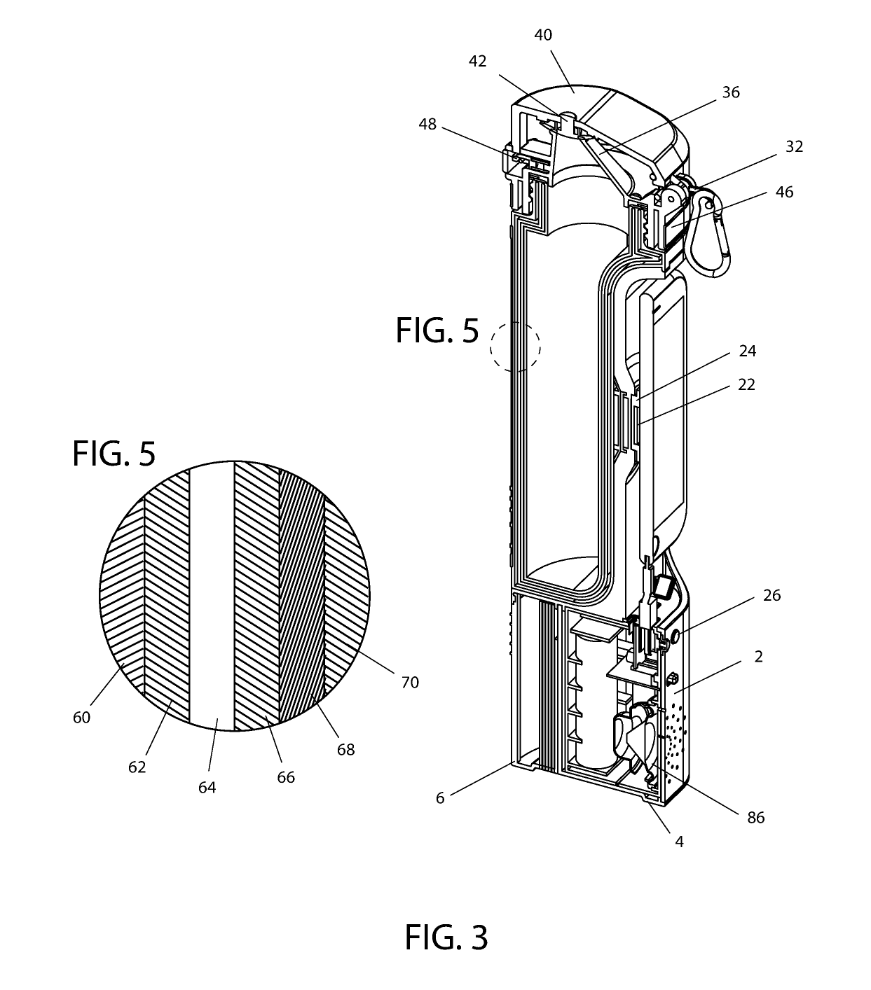

FIGS. 1 and 2 show the front and back views of the multipurpose bottle system. The bottle system includes a flip cap 40 mounted to a bottle 8 through which access to the contents of the bottle can be gained by opening or closing the flip cap. Referring also to FIG. 3, the flip cap 40 also may have a rubber stopper 42 mounted to its inner surface that is used to prevent the liquid in the bottle from leaking out of the bottle. The bottle system may also include a lock bottom 48 of the cap 40. The lock bottom 48 is used to help keep the flip cap 40 firmly closed when the user moves the flip cap 40 from an open position to a closed position. To open the flip cap 40, the user presses in on a movable button mechanism 56 mounted below or on the flip cap. The button mechanism 56 is in communication with a button 48, a grommet 50 and a rod 52. Pressing the button mechanism 56 releases the flip cap 40 so that it can be pivoted open.

A screw cap 36 is positioned below the rubber stopper 42 when the flip cap 40 is in a closed position. The user fills the bottle with water through an opening into the screw cap 36. The rubber stopper 42 interacts with the opening in the screw cap 36 to ensure the water does not leak out through the opening when the multipurpose water bottle is changed from one position to another. The screw cap 36 includes a threaded portion that is threadably mounted to a threaded portion 10 on the top of the bottle 8 by interacting with the threads on the bottle 8.

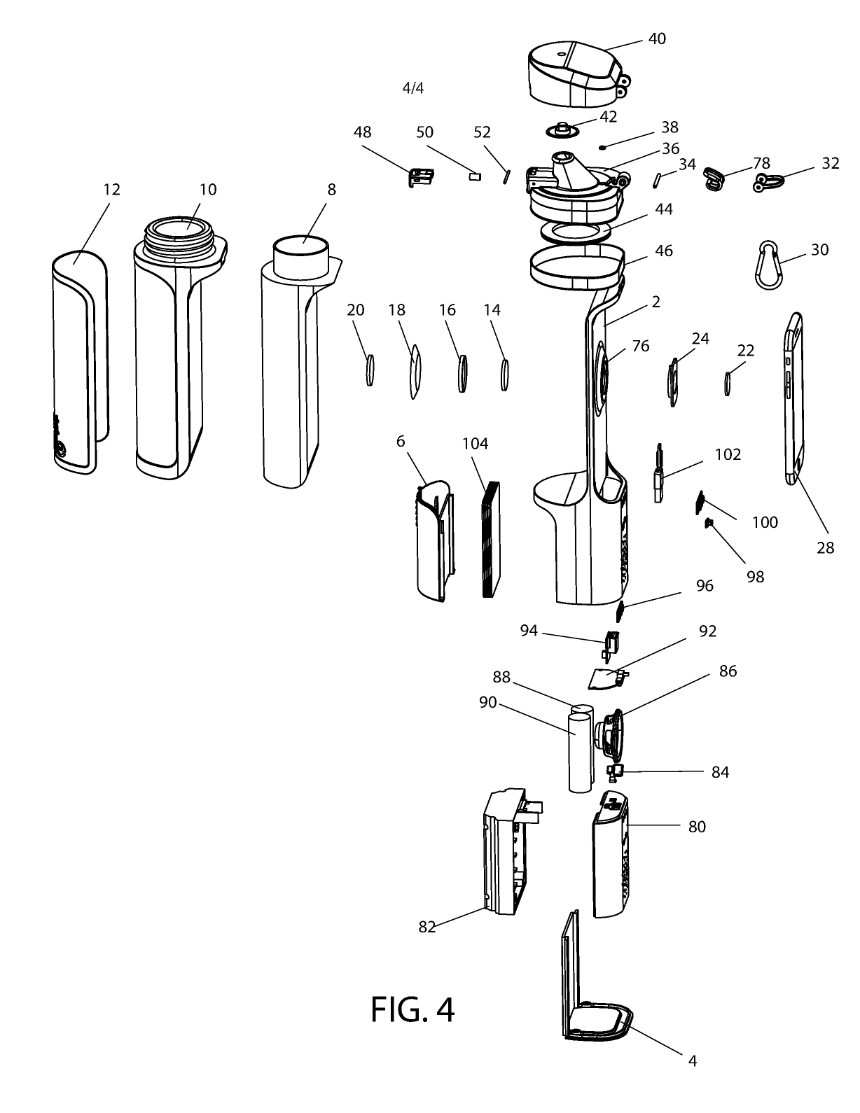

Referring also to FIGS. 4 and 5, the water bottle system includes a loop hanger 32 to which a Carabineer 30 can be mounted. The loop hanger 32 is mounted to the screw cap 36 by use of a mounting mechanism consisting of a pivot rod 34 and pivot loop 78. The loop hanger is mounted to the pivot rod, which also passes through the pivot loop and a mounting piece on the screw cap 36. Inclusion of the optional Carabineer 30 permits the user to hang the bottle on various objects such as jeans or pants, a bag, backpack or on a set of keys or other accessory.

Also associated with the screw cap 36 and flip cap 40 is an optional aroma scent 38, which may have the aroma of fruits or provide aroma therapy while drinking The aroma scent 38 is positioned under or adjacent to the flip cap 40 or on or adjacent to the screw cap 36. The aroma scent 38 may be removed and replaced with different scents or after the scent is no longer sufficient to be noticed.

FIGS. 1, 2, 3, and 4 illustrate the main part or body 2 of the multipurpose bottle which contains an on/off button 72 for the Bluetooth speaker(s) 86. The on/off power button 72 is mounted adjacent to the Bluetooth speaker, which in turn is mounted within the main part 2 adjacent to an opening through which the sound can pass. Positioned also in the main part 2 and adjacent to the power button 72 is a set of buttons 26 for operating the Bluetooth speaker. The buttons 26 may alternatively be in the form of a LCD touchscreen display that includes buttons for controlling volume, playback options and making/receiving telephone calls. The main part or body 2 may be made as a single piece of plastic through, for example, injection molding.

Positioned adjacent to the power button 72 is a charging port 74 for charging one or more internal batteries 88, 90 mounted within the bottle system. The charging port 74 may be configured as needed for receiving a charge, e.g., a USB port. It should be understood that the charging port 74 can be any interface used for receiving a charge to charge the batteries and a USB connection is merely one example of such an interface.

The body 2 also includes a magnet 14 embedded into the body, with an accompanying magnet cover 16, which may be a separate component or integral with the body 2 itself. The bottle 8 also will include a magnet 20 positioned on the outside of the bottle and which also will have a cover 18. The interaction between magnets 20 and 14 will secure the bottle to the main body. A similar mechanism is used to secure the phone to the main body. A phone magnet 22 is connected or mounted to a phone 28 with a magnet phone adapter 24. The magnet adapter has double-sided glue on its surface so that the phone can be strongly attached to the adapter. The magnet 22 is attracted to magnet 14; this interaction ensures the phone 28 is secured to the main body 2. It should be understood that as an alternative to the combination of the magnet phone adapter 24 and magnet 22, a separate phone cover may be provided that is modified to include a magnet or a magnetic surface to interact with the magnet 14 and secure the phone to the main body. As still yet another alternative, multiple magnets and magnet covers may be mounted to both the bottle and the main body to more firmly retain the water bottle to the main body. A similar arrangement may be made between the smart phone or smart phone cover and the main body to more firmly retain the smart phone to the main bottle.

The main body 2 also may include groves 76 adjacent to the magnet 14 to prevent rotational movement of the phone when mounted to the magnet 14 such that the phone can be attached to the bottle in either the horizontal or vertical direction and will be unlikely to shift position upon movement of the bottle system.

In addition to the magnets 14, 22 to secure the bottle 8 to the main body 2, additional features may be used to secure, guide or position the bottle relative to the main body. For example, FIGS. 1 and 5 illustrate a groove and tongue arrangement to position and guide the bottle onto the main body. For example, the water bottle 8 may include a tongue or extension that fits within a groove in the main body 2 at the top of the main body. This interaction prevents lateral movement of the bottle with respect to the main body. Further, as illustrated in FIG. 4, the water bottle 8 and the main body 2 are curved at upper regions such that they are flush with one another when the water bottle is placed against the main body. As alternatives to the curved upper regions, the bottle and main body may have other mating configurations to retain the bottle against the main body.

The main body 2 also includes an electronic box subassembly made up of a pair of mating halves parts 80 and 82, which holds a pair of rechargeable batteries 88 and 90 within a compartment formed by the two mating halves 80, 82. The batteries 88, 90 are used for two purposes. The first purpose is to recharge the phone and act as a backup battery bank for the phone. The batteries provide this function by transmitting electricity via USB outlet 94. An outlet adapter 102 is connected to it, which is specialized to specific phone models according to the phone power input.

Second, the batteries 88, 90 power the Bluetooth speaker(s) that are integrated into the system. A Bluetooth printed circuit board (PCB) 92 connects via Bluetooth or other radio frequency to the smartphone that is attached to the device and projects sound via the speaker 86. A bottom cover 4 holds the electronic sub-assembly mating halves 80, 82.

A storage chamber 6 is positioned within the device to act as a storage place for holding credit cards, IDs, or money such as shown by a personal item pocket 104, or any other important personal belongings.

FIG. 3 shows the functionality of the multipurpose bottle. The speaker 86, rechargeable batteries 88, 90 are used to recharge the phone and power the speaker. The bottom cover 4 holds all the electronics in the bottle and the personal item pocket 104 provides a means of holding ID cards, etc. A reflector ring 46 is positioned adjacent to the flip cap 40 and is used to reflect light during the night, and is useful for a person walking on the road or traveling at night.

FIG. 5 illustrates one configuration of the bottle for cooling the water in the multipurpose bottle. The outer layer 60 gives the user a comfortable grip. The exterior surface 62 of the multipurpose bottle has embedded between it and middle barrier 66, an air layer 64. This assembly acts as an insulator, so the external temperature is kept separate from the internal liquids of the bottle, allowing the liquid to sustain its own temperature better. Between middle barrier 66 and interior barrier 70, there is a layer of cooling gel 68. The cooling gel 68 can freeze and stay frozen for a long period of time, just like a freeze pack would. So before using the bottle, the user would place the entire bottle 10 in the freezer for several hours without the cap assembly, whereupon the cooling gel 68 would then freeze. When the user puts liquid inside the bottle, this would serve to cool the liquid, and keep it cooler for a longer period of time. It should be understood that the insulation system illustrated in FIG. 5 is one implementation and can be varied, for example, to consist of a single air layer between the inner and outer surfaces.

The present invention is very useful for users, as it can hold a cell phone in both the horizontal and vertical directions, while also charging their phone at the same time. Thus, users will not need to carry a charger or mobile case while traveling to or from work or the gym, which will save a lot of space.

This invention is also very useful as it can provide aroma therapy when drinking, and also has a reflector that shines at night, thus protecting the user while walking out on the road in the night time.

The multipurpose bottle may be varied with additional features depending upon the purpose. For example the multipurpose bottle may be fitted for outdoor uses by including a GPS tracker system and a SOS signal emitter. To ensure that the multipurpose bottle can be used in the outdoors away from power sources, a solar panel may be included to charge the batteries. The multipurpose bottle also may be waterproof and dust resistant to improve the longevity of the electronics. Further to ensure that the multipurpose bottle can be used in an outdoor environment, the product can be made of rugged military grade materials and be shock proof.

In another implementation, such as for use in a gym or yoga studio, the product can be provided with Bluetooth earbuds, a beverage mixer, and a second storage compartment for vitamins and supplements. The bottle also can be provided with a water infuser to infuse a fruit flavor to the water. The bottle also can be made to be shock proof.

While the bottle may be constructed with any or all of the features disclosed above, the exterior of the bottle can be decorated in numerous way. For example, the outside surface of the product can include characters from movies, television shows, or comic books. Such a model could be designed for children. Similarly, the outside surface of the product can include images of professional sports figures or sports themselves, e.g., college or professional sports. The outside surface can similarly be illustrated with logos of universities or organizations.

To use the multipurpose bottle system disclosed herein, a typical user would hold the base of the bottle system in one hand and use the other hand to lift the bottle 8 away from the main body 2. The interaction between the magnets 14 and 20 requires the user to exert sufficient effort to overcome the magnet force that secures the bottle 8 to the main body 2. With the bottle removed from the main body, the user then unscrews the screw cap 36/flip cap 40 to allow access to the opening in the bottle for filling the bottle with water. Upon filling the bottle with water and remounting the screw cap 36/flip cap 40 to the bottle, the user places the bottle 8 back in place against the main body 2. The user alternatively may place the filled bottle in a refrigerator to cool the water if desired and, once cool, mount the bottle 8 to the main body 2.

Next, if taking the multipurpose bottle out, the user may use the storage compartment 5 to hold items such as keys, credit cards and money. The user slides or pulls the storage chamber 6 away from the bottom cover 4 or main body 2, places the items within the storage chamber 6 and remounts the storage chamber to the bottom cover 4/main body 2.

If for example, the user next takes the multipurpose bottle to the pool, the user may then mount a smart phone to the main body 2. For example, if the phone has a metal back, the phone can be simply placed against the magnet 14 and held in place. Alternatively, the multipurpose bottle can be supplied with, or as a separately available item the user may have, a smart phone case with an integral magnet 22 to mate with the magnet 14.

The user then may decide to use the smart phone to play music or conduct a telephone or video call. The user powers the Bluetooth speaker by using the buttons 26 to receive and output music or a call from the smart phone to the speaker. The user may rotate the smart phone against the main body 2 with the magnet 22 retaining the phone and the grooved surface 76 preventing the phone from sliding or changing its desired position.

At any time when the user is listing to music or conducting a phone call through the Bluetooth speaker, the user can simultaneously remove the bottle 8 open the flip cap 40 can drink some of the water in the bottle.

After use of the phone, the user may determine that the charge in the phone is low and needs to be replenished. To recharge the batteries in the phone, the user connect the charging port on the phone, e.g., a micro-USB port on the bottom surface of the phone, and plugs that into the outlet adapter 102. In this configuration, current will flow from the batteries 88, 90 in the main body to the battery in the cell phone through the adapter 102 and charging port on the phone to the batteries in the phone to charge the phone batteries.

After an outing with the multipurpose bottle, the user may attach a USB or other charging cable to the outlet adapter 102 and charge the batteries 88, 90 in the multipurpose bottle. Once the batteries are charged, the charging cable is detached from the adapter 102 and the multipurpose bottle is ready for use in another outing.

The following components on the multipurpose bottle disclosed herein have the reference numbers assigned as set out below:

| Reference number | Component |
|---|---|
| 2 | main body |
| 4 | bottom cover |
| 6 | storage chamber |
| 8 | water bottle |
| 10 | threaded portion of bottle 8 |
| 12 | bottle grip surface |
| 14 | main body magnet |
| 16 | main body magnet cover |
| 18 | water bottle magnet cover |
| 20 | water bottle magnet |
| 22 | cell phone magnet |
| 24 | cell phone magnet adapter |
| 26 | Bluetooth operating buttons/control panel |
| 28 | smart phone |
| 30 | Carabineer |
| 32 | loop hanger |
| 34 | pivot rod |
| 36 | screw cap |
| 38 | fragrance or aroma scent |
| 40 | flip cap |
| 42 | rubber stopper |
| 44 | gasket |
| 46 | reflector |
| 48 | lock bottom |
| 50 | grommet |
| 52 | rod |
| 56 | flip cap movable opening button |
| 60 | outer layer of bottle grip 12 |
| 62 | exterior surface of the bottle 8 |
| 64 | air layer |
| 66 | middle barrier |
| 68 | cooling gel |
| 70 | interior barrier |
| 72 | power button |
| 74 | charging port |
| 76 | grooved surface |
| 78 | pivot loop |
| 80, 82 | mating halves of electronic box subassembly |
| 84 | USB charger interface |
| 86 | Bluetooth speaker |
| 88, 90 | batteries |
| 92 | Bluetooth printed circuit board (PCB) |
| 94 | USB outlet |
| 96/100 | Control buttons |
| 98 | On/Off switch |
| 102 | outlet adapter |
| 104 | card holder |

While the foregoing written description of the invention is considered presently to be the best mode thereof, others will understand and appreciate the existence of variations, combinations and equivalents of the specific embodiment, method, and examples herein. The invention should thereof not to be limited by the above embodiment, method, and examples, but by all embodiments and methods within the scope and spirit of the invention as claimed.

While specific embodiments of the present invention have been provided, it is to be understood that these embodiments are for illustration purposes and not limiting. Many additional similar variations will become apparent in the future.

What is claimed is:

1. A multipurpose water bottle which contains a main body and a water bottle removably mounted to the main body, wherein the main body includes a smartphone charger, a smartphone holder, and a Bluetooth speaker.

2. The multipurpose water bottle of claim 1, wherein the main body further comprises a storage chamber.

3. The multipurpose water bottle of claim 1, wherein the multipurpose water bottle further comprises a scent or fragrance tab which is configured to deliver aroma therapy.

4. The multipurpose water bottle of claim 1, wherein the main body further one or more batteries in electrical connection with the smartphone charger.

5. The multipurpose water bottle of claim 1, wherein the main body further includes a surface adjacent to the smartphone holder configured to hold the smartphone in either a horizontal or vertical direction while resisting rotational movement against the surface.

6. The multipurpose water bottle of claim 1, wherein the water bottle includes at least one layer of insulation.

7. The multipurpose water bottle of claim 1, wherein the main body includes a first magnet and the water bottle includes a second magnet wherein the first magnet on the main body and the second magnet on the water bottle are positioned such that mounting the water bottle to the main body causes the first magnet to be in magnetic contact with the second magnet.

8. The multipurpose water bottle of claim 7, wherein the main body includes a control panel configured to interface with a smart phone and the Bluetooth speaker to control one or more of volume through the Bluetooth speaker and operation of the phone.

9. The multipurpose water bottle of claim 1, wherein the multipurpose water bottle consists essentially of the main body and a water bottle and the main body consists essentially of a smartphone charger, a smartphone holder, and a Bluetooth speaker.
